(19) United States
(12) Patent Application Publication
(10) Pub. No.: US 2024/0381886 A1
(43) Pub. Date: Nov. 21, 2024

(54) PROCESS OF PRESERVATION OF VEGETABLES

(71) Applicant: MARCATUS QED INC., Toronto (CA)

(72) Inventor: Sundar MURALI, Toronto (CA)

(21) Appl. No.: 18/692,868

(22) PCT Filed: Sep. 15, 2022
(86) PCT No.: PCT/IB2022/058686

§ 371 Date: Mar. 18, 2024

(30) Foreign Application Priority Data
Sep. 17, 2021 (IN) 202141042094

(51) Int. Cl. A23B 7/10; A23B 7/04; A23B 7/157

(52) U.S. Cl. CPC A23B 7/10; A23B 7/0433; A23B 7/157

(57) ABSTRACT

The present invention relates to a process for preserving vegetables in bulk packs and repacking into smaller packs wherein the same media is used in repacking on as is basis.

### TECHNICAL FIELD

The present invention relates to a process for preserving vegetables. In particular, the present invention relates to preserving vegetables in bulk packs, which can be re-packed into retail packs on as is basis or with minimal changes in recipe or minimal processing requirements. Specifically, the present invention relates to a process which does not require de-acidification or disposal of brine media.

### BACKGROUND AND PRIOR ART

Presently bulk pack products contain vegetables preserved in high acid and high salt, with added preservatives as sulphites or benzoates. This product in bulk packs is de-acidified and then used for producing retail packs (jars/cans). The media in bulk packs is removed/disposed off and the vegetables are de-acidified. The vinegar and salt from original product is wasted and considerable amount of water is required to de-acidify. The natural sugars in the equilibrated media are also lost and the vegetables' taste profile is affected. New media is used to produce retail packs, per specific end recipe. De-acidification process also generates acidic effluents. The disposal is resource intensive and puts strain on the effluent plants and creates many environmental challenges. The physical and organoleptic characters are different from the retail packs which use fresh gherkins directly, i.e. ‘freshness’ perception is different.

Of the prior arts that address this problem include patent number WO2019000099A1 which provides a vacuum scaled container suitable for containing preserved pickled food. In a preferred approach, the container includes at least one foil wall formed from a flexible foil and defining a chamber; pickled food within the chamber; and brine, in which the food is immersed, and which fills the chamber when the chamber is sealed. Preferably, the ratio of brine to pickled food by mass is in the range 1:2.5 to 5. The claimed containers can reduce the mess associated with eating pickled foods from traditional containers, and can assist in improving the shelf life of such foods. U.S. Pat. No. 5,151,286A discloses a process for packaging acidified vegetables without a covering brine includes scaling the brineless vegetables in an opaque package. There is a quick equalization brine treatment which is used to reduce the respiration rate of fresh vegetables and reduce their pH to less than about 4.5 in less than about 6 hours. US20160090202A1 describes a system and method for making, cutting, and packaging pickled food items, such as pickled vegetables. The system is automated using a control computer or other controller subsystem. The system includes a conveyor for transporting pouches through the system. The pouches are optionally filled with spices and flavoring, liquids such as brining liquids for maintaining moisture of the vegetables placed within the pouch, a rotating drum for loading pickled vegetables into the pouches, a blade assembly for cutting the vegetables into portions, and a sealing device for sealing the pouches. U.S. Pat. No. 3,578,466A relates to enhancing on aging the flavour, colour, and texture of pickled vegetables by the addition of an edible alkylenediaminetetracarboxylic acid component in minor proportions. The alkylenediaminetetracarboxylic acid component is added either in a brine solution in which the vegetables to be pickled are treated, or in the pickling syrup solution during the manufacture of vegetable pickles. The alkylenediaminetetracarboxylic acid component is present in amounts ranging from 0.004% to 0.04%. There is a synergistic reaction between the alkylenediaminetetracarboxylic acid component and calcium chloride, the latter in 0.04 to 0.1% concentration, in providing aged products of improved crispness. EP0456368A pertains to a “reusable brine” and method for conserving cucumbers. The brine used for preservation is removed and used later for preservation of next lot of cucumbers. The stored cucumbers are put directly into cans etc. and additional pickling solution with other ingredients are added. The additional “spice pickling solution” implies de-acidification, if required, depending on initial acid percentage (pg. 2 line 46-acid 0.02-0.12 kg=2%-12%). So in this patent document, the focus is on preserving cucumbers and the brine used for preserving, is further reused for another round of preserving cucumbers. There may or may not be acidification step involved, for higher levels of acid, say 12%-which definitely is not safe for direct human consumption.

Non-patent literatures such as ‘Fruit and vegetable processing-Ch09 Vegetable specific processing technologies’ available on www.fao.org/3/V5030E/V5030E0S.html, uses vinegar, salt and calcium chloride in preserving for transport of pickled cucumbers and gherkins. The citation does not disclose bulk packing and storage of gherkins/vegetables in high molecular weight HDPE. Another citation, ‘Trends in Fruit and Vegetable Packaging’ by Mario Scetar et al, discloses the SAS permeability and water transmission rate (WTR) of polymeric film available for packaging of MAP produce and data for HDPE is provided. Whereas citation, ‘Fruit and vegetable processing-Ch07 Packaging materials’ available on http://www.foo.org/3/45030e/>5030e0h.htm, use of polyethylene in packaging for durability; heat-sealability; low permeability to water-vapour; good chemical resistance; good low-temperature performance. Another citation, https://www.ybdco.com/benefits-polyethylene-drums/, teaches use of HDPE for storing food. The article points out the benefits of using HDPE for storage purposes. Citation, https://www.researchgate.net/publication/331533088_CUCUMBER_VEGE TABLE_AS_A_BRINE_FERMENTED_PICKLE, teaches use of vinegar, salt and calcium chloride in preserving Gherkins. Yet another citation ‘Making Pickles’ by P. Kendall et al, which is the traditional pickling method, details of normal pickling (fermentation/acidification-addition of acids) method with significantly higher levels of acid, salt, sugar etc. Mentions use of “food grade plastic”.

However none of the patent or non-patent literature cited hereinabove discloses that the same brine media used in bulk packing and storage of the vegetables may be used for retail packaging. De-acidification or discarding of brine media leads to environmental issues due to effluents discharge besides loss of original taste, flavour or freshness of the preserved vegetable.

### OBJECTS OF THE INVENTION

Thus, it is one of the objects of the present invention to use the same media in the retail packaging as is used in the bulk packaging thereby avoid disposing off any media and thus avoiding environmental issues. It is a further object of the present invention to retain freshness and taste and flavour profile of the pickled vegetables by using the same media. It is a further object of the invention to avoid de-acidification process thus avoiding unnecessary additional process steps and its costs.

### SUMMARY OF THE INVENTION

The present invention relates to a process for preserving vegetables in bulk packs and repacking into smaller packs wherein the same media is used in repacking on as is basis.

### DETAILED DESCRIPTION

The following description particularly mentioning the nature of this invention and the manner in which it is to be performed.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” The term “about” or “approximately” means within an acceptable error range for the particular value as determined by a person skilled in the art, which will depend in part on how the value is measured or determined, i.e., the limitations of the measurement system. For example, “about” can mean within one or more than one standard deviation, per the practice in the art. Alternatively, “about” can mean a range of up to 20%, of a given value. Where particular values are described in the application and claims, unless otherwise stated the term “about” meaning within an acceptable error range for the particular value should be assumed. Unless otherwise defined, all technical and scientific terms used herein have the same meaning as commonly understood by a person skilled in the art to which this invention belongs.

Hereinafter, there is described a process for the production for preserving vegetables. The process comprises the steps of receiving, cleaning, sorting of vegetables for removing defects and grading according to size, weight and count. A media comprising at least one of each acid, salt and calcium chloride is added to the vegetables placed in HDPE or HMHDPE bulk containers for acidification. The packing ratio of vegetables to media is around 55:45 to 60:40. The bulk containers are chilled and stored in the HDPE or HMHDPE bulk containers and temperature is maintained at 3-5° C. The HDPE or HMHDPE bulk containers are transferred to packaging area in which re-packing is done into smaller packs followed by pasteurisation of said smaller packs. Pasteurisation is done as per prescribed standard methods following time/temperature profiles prescribed by standard authorities. Additives such as spices, flavouring agents may be added before re-packing into smaller packs. It is important to note that this process does not require de-acidification or discarding of media before re-packing into smaller packs but the same media is transferred to said smaller packs. Thus the process does not include any additional process steps for de-acidification or any such processes.

Thus advantageously, the process of the present invention is to preserve vegetables in bulk packs, which can be re-packed into smaller packs on as is basis or with minimal changes in recipe or minimal processing requirements. The product is maintained at controlled temperature environment to retain the organoleptic and physical characteristics, throughout the supply chain, during shipment, till delivery and usage. No preservatives are required to be added. All required food safety and quality parameters are achieved and maintained. The preserved vegetables retain their original physical parameters as freshness, texture, as the original ‘fresh’ packs.

The same media can be utilized to pack vegetables into smaller packs. No de-acidification or media disposal is required. The end processor can save on media i.e. acid, salt, water which in turn means costs in the end recipe. There is no effluent discharge and associated costs, therefore there is no financial or environmental burden. Hence the process of the present invention is environmentally responsible, economically viable and sustainable. The usage of same media also means enhanced flavor profile as the natural sugars from the vegetable are retained.

Vegetables preserved are selected from gherkins, cucumbers, different types of peppers, cauliflowers, onions, carrots, baby corn, okra or any such vegetable which is capable of being preserved by acidification. The type of vinegar is selected based on requirements of flavour profile of the end profile.

The final or end value of these parameters required in the preserved vegetable is around 0.6 to 0.8% of acidity, salt is around 2.2-2.8% and calcium chloride is around 0.3 to 0.35%. However, the actual amount of acid, salt and calcium chloride to be added in the process depends on the packing ratio, salts and minerals present in the water source to achieve the final required parameters. For illustrative purposes for better understanding, assuming plain water with zero minerals/salts present and a packing ratio of 60:40 vegetables to media, the initial acidity value is around 0.80%, salt value is around 2.80% and calcium chloride value is around 0.35%.

### Examples

The present invention is hereinafter illustrated by way of an exemplary embodiment for better understanding but is not intended to limit the scope of the disclosure. While they are typical of those that might be used, other procedures, methodologies or techniques known to those skilled in the art may alternatively be used. In this regard, the present example embodiment may have different forms and should not be construed as being limited to the descriptions set forth herein. Accordingly, the example embodiments are merely described below for the purpose of explanation only.

Exemplary Embodiment—Gherkins were received, soaked in the tank to clean, sorted to remove defects and graded according to weight, size, counts etc. Packing was done into 2 HMHDPE barrels-high molecular weight high density polyethylene barrels—240 l, with screw type closure for acidification. The media comprised of vinegar, salt and calcium chloride with the packing ratio of product to media between 55:45 and 60:40. The initial chemical parameter was set to achieve the final spec of acidity—0.65 to 0.8%, salt—2.3 to 2.8%, Calcium chloride-0.3 to 0.35%. After packing, the barrels were stored in chiller room at an approximate temperature of 3° C. to 5° C. Periodic tests were done on the product packed, below is the detail of analysis below:
1. First analysis was done after 22 day from the date of packing for chemical and organoleptic parameters.
   All samples were tested for chemical parameter & physical parameters. No yeast and mould growth noticed on the top when the barrel was opened, media was visibly clear, fruits were crisp & firm.
      Temperature in chiller was below 5° C.
      Acidity was ranging from—0.8 to 1.11%
      Salt was ranging from—2.3 to 2.8%
      Calcium was ranging from—1600 to 2400 ppm
      pH was ranging from—3.56 to 3.82
2. Second analysis was done after 31 days from DOP for chemical and organoleptic parameters.
   All samples were tested for chemical parameter & physical parameters. No yeast & mould growth noticed on the top when the barrel was opened, media was visibly clear, fruits were crisp & firm.
      Temperature in chiller was below 5° C.
      Acidity was ranging from—0.8 to 1.11%
      Salt was ranging from—2.3 to 2.7%
      Calcium was ranging from—1500 to 1700 ppm
      pH was ranging from—3.5 to 3.7
3. Third analysis was done after 39 days for microbiological parameters.
   Total plate count (TPC)—ranged from min. 4.3*102 to max. 4.2*10) 3 cfu/g.
   Yeast and mould—samples resulted <10 cfu/g.
   Salmonella—sample resulted absent/25 g.
   E. coli—all sample resulted <10 cfu/g.
   Coliform—all sample resulted <10 cfu/g.
   Listeria Monocytogenes—all sample resulted absent/25 g.
   Note: The sample was drawn by the lab personal and the sample were taken in ice box to maintain the temperature.
4. Fourth analysis was done after 85 days for chemical and organoleptic parameters.
   All samples were tested for chemical parameter & physical parameters. No yeast and mould growth noticed on the top when the barrels were opened, media was visibly clear, fruits were crisp and firm.
   Temperature in chiller was below 5° C.
   Acidity was ranging from—0.9 to 1.1%
   Salt was ranging from—2.3 to 2.7%
   Calcium was ranging from—1500 to 1600 ppm
   pH was ranging from—3.5 to 3.6
5. Fifth analysis after 93 days from DOP for sensory parameters.
   ½ kilo sample was drawn from each barrel. Gherkins colour was consistent for all trial. Texture was firm on all samples. Sample #1 was comparatively high on crispiness comparatively, but others were firm and crispy. Media appearance was clear, no turbidity noticed across sample. Based on sensory evaluation, further internal study and R&D were carried out.
   Note: 4 jars from each trial were pasteurized.
6. Sixth analysis was after 107 days from DOP for microbiological analysis.
   The microbiological test results of four trials are below;
   Trial #1—TPC-1.6×10³ cfu/g; E. coli <10 cfu/g; Coliform <10 cfu/g and pH was 3.76
   Trial #2—TPC-3.1×10³ cfu/g; E. coli <10 cfu/g; Coliform <10 cfu/g and pH was 3.69
7. Seventh analysis was after 175 days from DOP on the finished product prepared for its sensory evaluation.
   The next step was using three jars from each trial and making to finished product (pasteurised). The product was tested for sensory parameter. They were good in terms of appearance (both gherkins and brine), texture, taste and smell.
8. Eighth analysis was done after 184 days from DOP for sensory comparing the sample packed from trial and fresh
   Further to above sensory evaluation on the finished product, a fresh pack (using fresh gherkins) was produced using same recipe and a comparative sensory was conducted.
   The comparative result showed;
   First closest to fresh pack—trial #2
   Second closest to fresh pack—trial #1
9. Ninth analysis was done after 191 days from DOP for chemical parameter and TPC.
   Trial #1-Acidity-1.04%, Salt-2.44%, pH-3.80 & TPC-3.4×102 cfu/g.
   Trail #2-Acidity-1.02%, Salt-2.47%, pH-3.82 & TPC-8.6×102 cfu/g.
10. Based on the above test results, the process and products were considered promising.
   As on date, the product are 237 days old (nearly 7.5 months).

| | | | Treat- | Treat- | | Treat- |
|---|---|---|---|---|---|---|
| | | | ment | ment | Treat- | ment |
| | Pro- | Gherkin | #1 | #2 | ment | #4 |
| | curement | Tem- | (Wash- | (Blanch- | #3 | (Final |
| Trial | (farm to | perature | ing | ing | (Media | storage |
| No. | factory) | in crate | Type) | type) | type) | type) |
| | Normal | 30.6- | Normal | None | Normal | After |
| | pro- | 31.8° C. | washing | | Media | packing, |
| | curement | | with | | filled | drum was |
| | as per | | water | | into | stored in |
| | current | | (32° C.) | | drum | chiller |
| | industrial | | | | (31.3° C.) | (Below |
| | practice | | | | | 5° C.) |
| 2 | Normal | Product | Normal | None | Normal | After |
| | pro- | was | washing | | Media | packing, |
| | curement | stored | with | | filled | drum was |
| | as per | in cold | water | | into | stored in |
| | current | room | (34.2° C.) | | drum | chiller |
| | industrial | with | | | (31.5° C.) | (Below |
| | practice | 23-24° C. | | | | 5° C.) |

As stated hereinabove, the example embodiments of the present inventive concepts have been described with reference to the drawings are for illustrative purposes only and cannot limit the scope of the invention. A person skilled in the art will appreciate that various modifications and other equivalent embodiments are possible from those described herein in this document. Therefore the scope of the present invention should be defined by the accompanying claims.

1. A process for preservation of vegetables in bulk packaging followed by repacking into smaller packs, said process comprising the steps of:
a. receiving, cleaning, sorting of vegetables and placing in HDPE or HMHDPE bulk containers for acidification;
b. adding media comprising at least one of each acid, salt and calcium chloride to the vegetables placed in HDPE or HMHDPE bulk containers for acidification;
c. chilling and maintaining the HDPE or HMHDPE bulk containers comprising the preserved vegetable and media at 3-5° C.,
d. repacking the preserved vegetable and its media into smaller packs followed by pasteurization;
wherein during (d), the media from the bulk container is not discarded but reused for smaller packs without undergoing any additional process steps of de-acidification.

2. The process as claimed in claim 1, wherein the packing ratio of vegetables to media is around 55:45 to 60:40.

3. The process as claimed in claim 1, wherein the acid is acetic acid or vinegar or different types of vinegar thereof depending on required end flavour profile.

4. The process as claimed in claim 1, wherein initial amount of acid is added is to achieve acidity value of 0.6%-0.8% w/v in preserved vegetable.

5. The process as claimed in claim 1, wherein the amount of salt added is to achieve the salt value is 2.2-2.8% w/v in the preserved vegetable.

6. The process as claimed in claim 1, wherein the amount of calcium chloride added is to achieve the value of 0.3 to 0.35% in preserved vegetable.

7. The process as claimed in claim 1, wherein additives such as spices, flavouring agents may be added before re-packing into smaller packs.

8. The process as claimed in claim 1, wherein the vegetables is selected from one or more of gherkins, cucumbers, different types of peppers, cauliflowers, onions, carrots, baby corn, okra or any such vegetable which is capable of being preserved by acidification.
